(19) United States
(12) Patent Application Publication
(10) Pub. No.: US 2015/0284979 A1
(43) Pub. Date: Oct. 8, 2015

(54) Externally Operated Semi-Automatic Door Securing System

(71) Applicant: Richard Brasco Brandon, Jackson, MS (US)

(72) Inventor: Richard Brasco Brandon, Jackson, MS (US)

(21) Appl. No.: 14/680,418

(22) Filed: Apr. 7, 2015

Related U.S. Application Data
(60) Provisional application No. 61/995,322, filed on Apr. 8, 2014.

(51) Int. Cl. E05C 19/00

(52) U.S. Cl. CPC E05C 19/003

(57) ABSTRACT

The present disclosure provides an externally operated semi-automatic door securing device comprising a transverse bar; a cable, wherein the cable is attached to the transverse bar; a pulley, wherein the cable is routed through the pulley; at least one bracket; and an access box located on the exterior of the door.

### CROSS-REFERENCE TO RELATED APPLICATIONS

This application claims the benefit of, and priority to, pending U.S. Provisional Application No. 61/995,322 filed Apr. 8, 2014 titled “Externally Operated Semi-Automatic Transverse Security Bar.”

### FIELD OF THE INVENTION

The invention relates generally to a system useful for security and more specifically relates to a system particularly useful while using a transverse bar for securing a door.

### BACKGROUND ART

Transverse bars have been used in the past to secure doors from the inside. In addition to a simple door lock, the transverse bar allows for more strength and support, providing more resistance to outside forces pushing in. However, traditional transverse bar arrangements only provide security when a person is inside the premises and able to engage or remove the bar from the inside. Because many property owners may desire to protect the interior of a premises at all times, whether someone is inside or not, traditional transverse bars have limitations. Therefore, the need exists for a transverse bar security system that can be operated from either the interior or the exterior of the premises.

The present invention provides a system which can be operated from either the inside or the outside, allowing for extra security whether or not a person is within the premises. An authorized operator may gain access to the system through an exterior, locked box, and may then disengage the transverse bar from its secured position. The present invention also provides for added security with the ability to include more than one transverse bar. In addition, the present invention contemplates both manual and electric options, allowing for even more flexibility.

### SUMMARY OF THE INVENTION

In view of the foregoing shortcomings inherent in the conventional type of methods and systems now present in the prior art, the present invention provides a system for securing an entryway on the interior side, but which can be manually or electrically operated from the exterior side of the entryway by accessing lockboxes.

In one embodiment, the externally operated semi-automatic door securing device comprises a transverse bar; a cable, wherein the cable is attached to the transverse bar; a pulley, wherein the cable is routed through the pulley; at least one bracket; and an access box located on the exterior of the door.

In another embodiment, the externally operated semi-automatic door securing device comprises a transverse bar; a cable, wherein the cable is permanently attached to the transverse bar; a second cable, wherein the second cable is detachable from the transverse bar; a spindle, wherein the cable and the second cable are attached to the spindle; at least two brackets; and an access box located on the exterior of the door.

Other objects and advantages of the present invention will become obvious to the reader and it is intended that these objects and advantages are within the scope of the present invention.

To the accomplishment of the above and related objects, this invention may be embodied in the form illustrated in the accompanying drawings/pictures, recognizing however, that the drawings are illustrative only, and that changes may be made in the specific construction illustrated and described within the scope of the appended claims.

### BRIEF DESCRIPTION OF DRAWINGS

It should be noted that identical features in different drawings are shown with the same reference numeral. Various other objects, features and attendant advantages of the present invention will become fully appreciated as the same becomes better understood when considered in conjunction with the accompanying drawings.

FIG. 1 is an interior view of one embodiment of the externally operated semi-automatic door securing system.

FIG. 2 is an interior view of an alternative embodiment of the externally operated semi-automatic door securing system.

FIG. 3 is an interior view of an alternative embodiment of the externally operated semi-automatic door securing system, showing the security bar in a movable position.

FIG. 4 is an interior view of an alternative embodiment of the externally operated semi-automatic door securing system, showing the security bar in a stored position.

FIG. 5 is an exterior view of an alternative embodiment of the externally operated semi-automatic door securing system.

FIG. 6 is a top view of a security bar for an alternative embodiment of the externally operated semi-automatic door securing system.

FIG. 7 is an interior view of the components of a pulley housing for an alternative embodiment of the externally operated semi-automatic door securing system.

FIG. 8 is an exterior and side view of an alternative embodiment of the externally operated semi-automatic door securing system.

### DETAILED DESCRIPTION

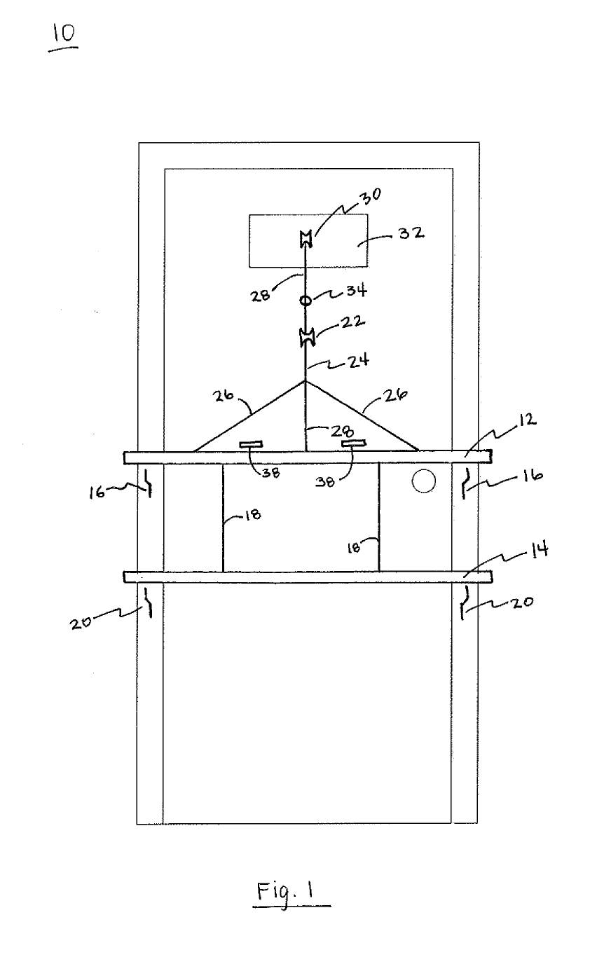

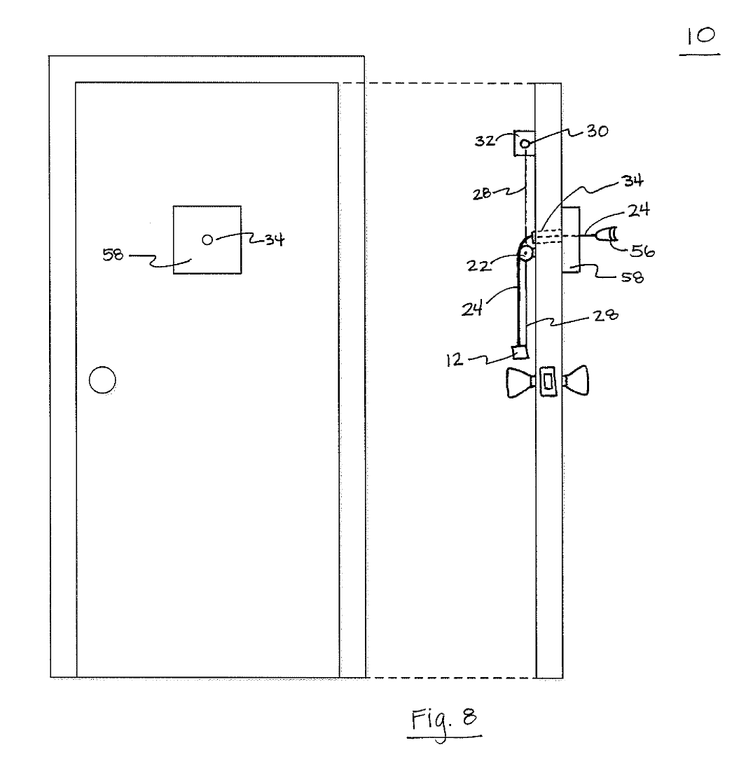

FIGS. 1 through 8 illustrate various views and embodiments of the present invention. In one embodiment, shown in FIG. 1, the system 10 comprises a manually operated pulley 22 as well as an electric pulley 30 as a backup option. The system 10 comprises a transverse bar 12 attached to a Y-cable 26, which is in turn attached to a primary cable 24. The primary cable 24 runs over the pulley 22 and through the cable eye 34 to the exterior side of the door. The exterior side of the door may contain an exterior security box 58, as shown in FIG. 8 and further described below. In addition, the bar 12 may be attached to an electric cable 28, which runs vertically and behind the primary cable 24. The electric cable 28 is routed inside a pulley housing 32 and over an electric pulley 30. To secure the door, the bar 12 is lowered until it rests in the brackets 16, which are placed on either side of the door. The brackets 16 may be placed on the door frame itself, or farther out from the door on the wall. In its secured position, the system 10 keeps the door from opening to the inside. To unsecure the door, the bar 12 is raised out of the brackets 16 until it completely clears the brackets 16. The system 10 may have magnetic stops 38 which can hold the bar 12 in an unsecured position while security is not needed. Finally, for added security the system 10 may also comprise an auxiliary bar 14, which is connected to the bar 12 in parallel fashion by auxiliary cables 18. When the bar 12 is lowered into its secured position, the auxiliary bar 14 is also lowered into the auxiliary brackets 20, allowing for the extra protection.

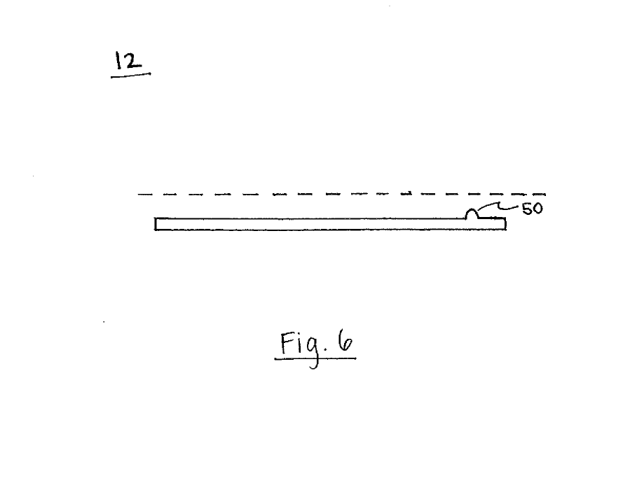

The bar 12 may be made of any number of materials, including but not limited to, wood, metal, plastic, or composite, depending on user preference and desired strength. In addition, the bar 12 may have differing shapes. Although the bar 12 is shown in a rectangular form, it may have a cylindrical shape, rounded edges, angled ends, or have a decorative overall shape or other decorative features. For example, in FIG. 6, the bar 12 is shown from a top view as having squared-off ends. However, the bar 12 may have ends that taper away from the door surface, which may assist in raising and lowering the bar, as it may be less likely to bump or catch the door frame surfaces. Similarly, the brackets 16 may be made of any number of materials, have various overall shapes, or have decorative features, depending on user preference.

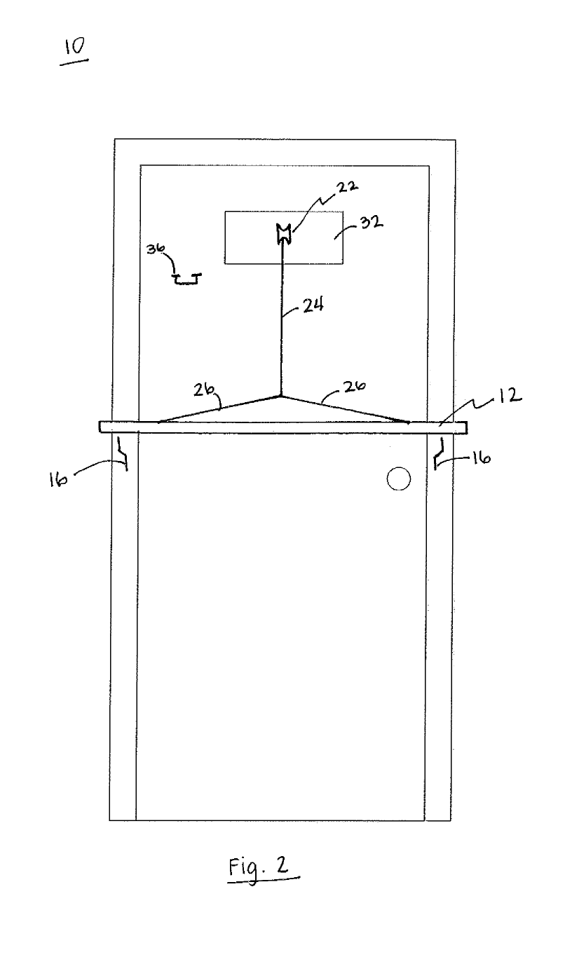

An alternative embodiment of the system 10 is shown in FIG. 2. In this embodiment, the system 10 is only manually operated. The pulley 22 is located inside a pulley housing 32, and the primary cable 24 extends from the pulley 22 outside the pulley housing 32 and down toward the bar 12. The primary cable 24 is connected to a Y-cable 26, which is then attached to the bar 12. For exterior manual operation, the exterior side of the door may contain an exterior security box 58, as shown in FIG. 8 and further described below. In this embodiment, there is only a single bar 12, though another may be added to this manual system 10 for extra security, similar to that shown in FIG. 1. This embodiment also shows a vertical holder 36, which can be used to store the bar 12 when not in use. The vertical holder 36 may be magnetic, or it may be a hook, grip, nail or other mechanism which may be used to hang or hold the bar 12.

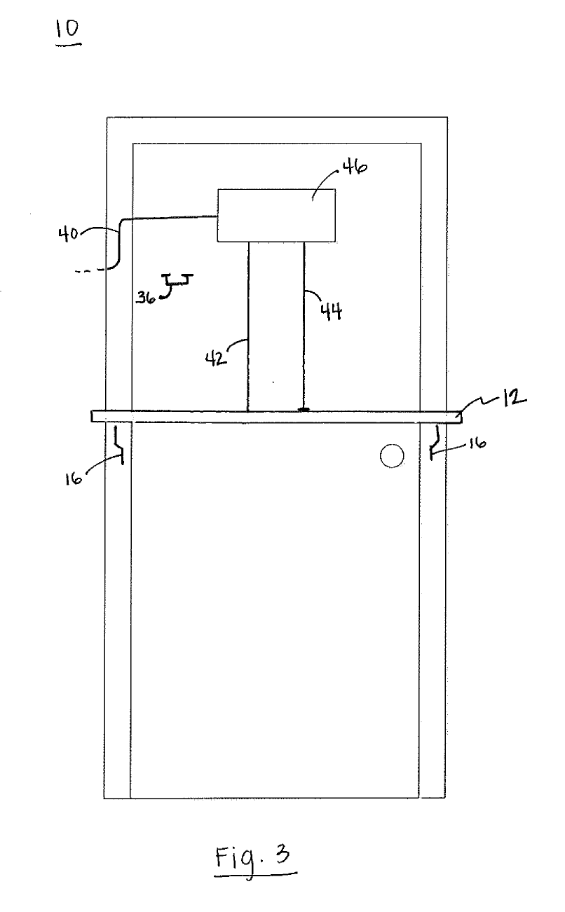

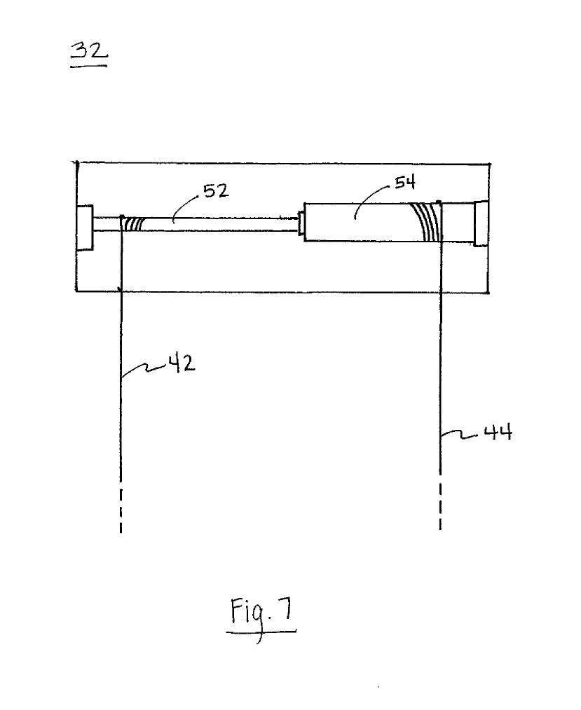

Another alternative embodiment of the system 10 is shown in FIG. 3. In this embodiment, a double-cabled method is used for raising, lowering, and storing the bar 12. An electric power box 46, supplied by a power cord 40, may house a pulley arrangement, or it may house a spindle arrangement as shown in FIG. 7 and further described below. While an electric operation is shown, this double-cabled system 10 could also be operated manually. As shown, the bar 12 in this embodiment is attached to a permanent cable 42 as well as a detachable cable 44. The bar 12 is raised and lowered into the brackets 16 to unsecure and secure the door. The detachable cable 44 can be removed from the bar 12 in order to store the bar 12 in the vertical holder 36.

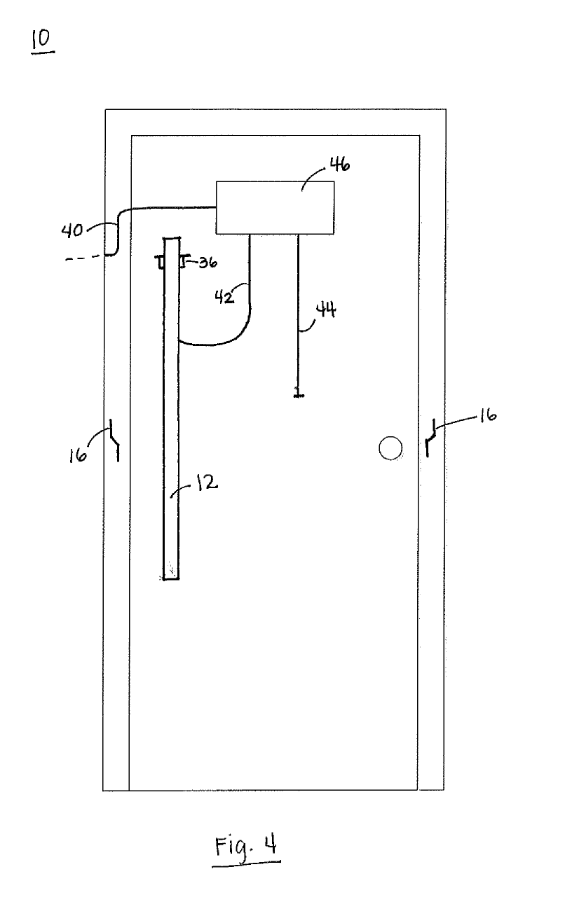

FIG. 4 shows the embodiment described above and shown in FIG. 3. In this view, the bar 12 is shown in a stored position, vertically in the vertical holder 36. The detachable cable 44 is also shown as removed from the bar 12. This arrangement allows the bar 12 to be stored vertically without the need for completely disconnecting the bar 12 from the rest of the system 10.

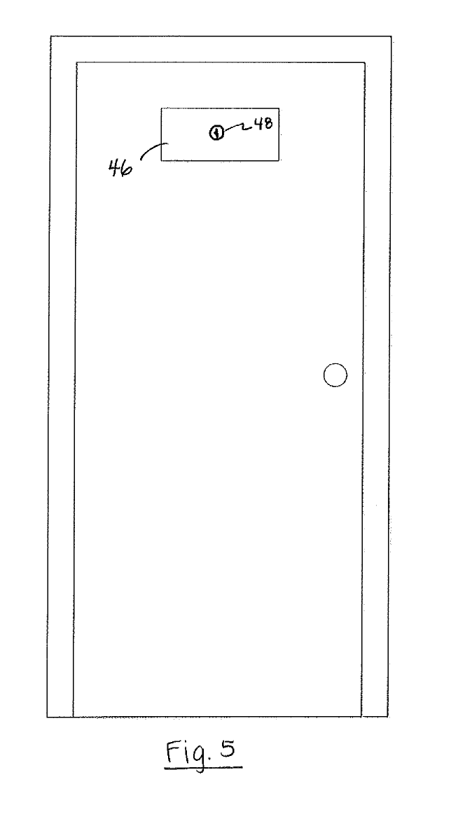

FIG. 5 shows an exterior view of one embodiment of the system 10. In this embodiment, the system 10 may comprise an electric power box 46 on the door exterior. This electric power box 46 may be opened through an outside key access 48. This exterior component of the system 10 allows a person to approach the door, secured with the bar 12 from the inside, open the electric power box 46 with a key, and disengage the bar 12. The manner in which the person could activate the system 10 and begin to disengage the bar 12 could be accomplished by a button, switch, lever, keypad, or even a touch screen arrangement. Moreover, the exterior component of the system 10 as shown in this FIG. 5 is electrical, but this exterior box could also be implemented in the manual version of the system 10 as described herein. For example, the exterior box may still have an outside key access 48, but rather than a button or switch to activate the electrical component of the system 10, the exterior box may contain a handle which the operator may pull to disengage the system 10 from the outside. Finally, the electric power box 46 may function as an override mechanism in case of power failure or other type of system 10 malfunction. In such circumstances, the operator would be able to use the outside key access 48 to disengage the system 10.

An optional component of the system 10 is shown in FIG. 6, which is a top view of the bar 12. In this embodiment, the bar 12 may include a slack stopper 50 along the length of the bar 12. This slack stopper 50 may be a protrusion, hook, eyelet, or other attachment which is connected to the bar 12 on its door-facing side. The cable or cables, whether the primary cable 24, Y-cable 26, auxiliary cable 18, permanent cable 42, or detachable cable 44, may be connected to the bar 12 via the slack stopper 50. The slack stopper 50 functions to prevent excess slack in the cables which are attached to the bar 12. The slack stopper 50 may be adjusted along the length of the bar 12 in order to maintain cable tautness as necessary.

An alternate embodiment of the slack stopper 50 may have a function which pertains not to the cables, but instead to the bar 12 itself. The slack stopper 50 may be a knob that is attached to the bar 12 on its door facing side, and which knob may be adjusted so that it moves in toward the bar 12 and away from the door surface, or conversely, outward from the bar 12 and toward the door surface. This embodiment of the slack stopper 50 allows for the creation of a smaller gap between the door and the bar 12, which in turn adds security. The slack stopper 50 may be adjusted so that it touches the door surface, where there is no space at all between the bar 12 and door. Again, this adds security by preventing an unauthorized person from opening the door even a small amount before coming into contact with the engaged bar 12.

FIG. 7 shows the interior of a pulley housing 32 in accordance with one embodiment of the present invention. In this embodiment, the pulley housing 32 contains a spindle arrangement for raising and lowering the bar 12. This spindle arrangement may be useful when the system 10 comprises a 2-cable arrangement, perhaps using one permanent cable 42 and one detachable cable 44. The spindle comprises a small shaft 52 and a large shaft 54, with the two shafts being connected in line with one another such that they rotate about the same longitudinal axis. Although this embodiment shows the small shaft 52 attached to the permanent cable 42, and the large shaft 54 attached to the detachable cable 44, other combinations may be used. In this arrangement, the permanent cable 42 and detachable cable 44 both become wrapped around the small shaft 52 and the large shaft 54, respectively, lifting the bar 12 out of the brackets 16 and thus unsecuring the system 10. The purpose of having a large shaft 54 with greater diameter than the small shaft 52 is to lift one side of the bar 12 at a faster rate than the other side of the bar 12. This arrangement allows for the bar 12 to be brought into a near-vertical position in relation to the door. However, the spindle could also be comprised of one single-diameter shaft, which would lift the bar 12 in a horizontal manner. Other arrangements for the interior of the pulley housing 32 are contemplated by the present invention, such as one single traditional pulley 22 in the case of a single-cable system 10.

In FIG. 8, one embodiment of a manual version of the system 10 is shown with a backup electrical mechanism. In this embodiment, the system 10 comprises an exterior security box 58 on the exterior side of the door. The exterior security box 58 may be lockable as described in relation to FIG. 5 above. The exterior security box 58 may contain a pull handle 56, which is attached to the primary cable 24. The primary cable 24 is routed through the door by way of a cable eye 34, leading to the interior side of the door. Once on the interior side of the door, the primary cable 24 is directed over a pulley 22, and extends downward until its attachment to the bar 12. In this embodiment, an operator may simply pull the pull handle 56 away from the door itself, and this motion lifts the bar 12 from its brackets 16. This embodiment also shows a backup electrical option, where an electrical component may be inside the pulley housing 32. The electric cable 28 may run close to the door, behind the primary cable 24, where it attaches to the bar 12. Although this figure shows the exterior security box 58 as containing only the manual pull handle 56, the exterior security box 58 may contain both manual and electrical components, allowing an operator access to the manual arrangement as well as the backup electrical arrangement.

While the invention has been discussed as being useful for securing a door, it should be recognized that the system 10 can be used for other purposes and in other arrangements, such as the securing of a window or other type of entry point.

What is claimed is:

1. A semi-automatic door-securing system comprising:
a. a transverse bar positioned horizontally across an interior of a door;
b. a cable, wherein the cable is attached to the transverse bar;
c. a pulley, wherein the cable is routed through the pulley;
d. at least one bracket; and
e. an access box located on the exterior of the door.

2. The semi-automatic door-securing system of claim 1 further comprising a pulley housing.

3. The semi-automatic door-securing system of claim 1 further comprising a second cable,
wherein the second cable is attached to the transverse bar; and
wherein the second cable is routed through the pulley.

4. The semi-automatic door-securing system of claim 3,
wherein the cable is permanently attached to the transverse bar; and
wherein the second cable is detachable from the transverse bar.

5. The semi-automatic door-securing system of claim 1 further comprising a second transverse bar, wherein the second transverse bar is connected to the transverse bar by an auxiliary cable.

6. The semi-automatic door-securing system of claim 1 further comprising a vertical holder for storing the transverse bar.

7. The semi-automatic door-securing system of claim 1 further comprising a magnetic stop, wherein the transverse bar can be held in position by the magnetic stop when not in use.

8. The semi-automatic door-securing system of claim 1 further comprising a cable eye wherein the cable is routed through the width of the door to the exterior side of the door.

9. The semi-automatic door-securing system of claim 8 further comprising a pull handle,
wherein the pull handle is attached to the cable; and
wherein the pull handle is located on the exterior side of the door.

10. The semi-automatic door-securing system of claim 1 further comprising an electric power box.

11. The semi-automatic door-securing system of claim 10 further comprising a spindle,
wherein the spindle is attached to the cable; and
wherein the spindle is located within the electric power box.

12. The semi-automatic door-securing system of claim 1 further comprising an attachment on the transverse bar,
wherein the attachment can be linked to the cable; and
wherein the attachment can be adjustable along the length of the transverse bar.

13. A semi-automatic door-securing system comprising:
a. a transverse bar positioned horizontally across an interior of a door;
b. a cable, wherein the cable is permanently attached to the transverse bar;
c. a second cable, wherein the second cable is detachable from the transverse bar;
d. a spindle, wherein the cable and the second cable are attached to the spindle;
e. at least two brackets; and
f. an access box located on the exterior of the door.

14. The semi-automatic door-securing system of claim 13,
wherein the spindle comprises two shafts; and
wherein one of the shafts is larger in diameter than the other.

15. The semi-automatic door-securing system of claim 13 further comprising a second transverse bar, wherein the second transverse bar is connected to the transverse bar by an auxiliary cable.

16. The semi-automatic door-securing system of claim 13 further comprising a vertical holder for storing the transverse bar.

17. The semi-automatic door-securing system of claim 13 further comprising a magnetic stop, wherein the transverse bar can be held in position by the magnetic stop when not in use.

18. The semi-automatic door-securing system of claim 13 further comprising a cable eye wherein the cable is routed through the width of the door to the exterior side of the door.

19. The semi-automatic door-securing system of claim 18 further comprising a pull handle,
wherein the pull handle is attached to the cable; and
wherein the pull handle is located on the exterior side of the door.

20. The semi-automatic door-securing system of claim 13 further comprising an electric power box.
